(19) United States
(12) Patent Application Publication
(10) Pub. No.: US 2023/0196380 A1
(43) Pub. Date: Jun. 22, 2023

(54) MOBILE CAMERA FOR VALIDATION

(71) Applicant: Rehrig Pacific Company, Los Angeles, CA (US)

(72) Inventors: Peter Douglas Jackson, Alpharetta, GA (US); Dane Gin Mun Kalinowski, Foothill Ranch, CA (US)

(21) Appl. No.: 18/083,764

(22) Filed: Dec. 19, 2022

Related U.S. Application Data
(60) Provisional application No. 63/290,747, filed on Dec. 17, 2021.

(51) Int. Cl. G06Q 30/018; H04N 23/56; G06V 20/62; H04N 23/90; G06K 7/10; G03B 17/56

(52) U.S. Cl. CPC G06Q 30/018; H04N 23/56; G06V 20/63; H04N 23/90; G06K 7/10366; G03B 17/561

(57) ABSTRACT

A mobile camera unit includes a base having a plurality of wheels. A support extends upward from the base. At least one camera mounted to the support. At least one processor is configured to collect images from the at least one camera. A communication circuit is configured to transmit the images. The mobile camera unit may be used to capture images of a plurality of products on a pallet or other platform. The images are transmitted to a server to identify SKUs associated with the products and to compare the identified SKUs with an order or pick list.

### BACKGROUND

The delivery of products to stores from distribution centers has many steps that are subject to errors and inefficiencies. When the order from the store is received, at least one pallet is loaded with the specified products (SKUs) according to a “pick list.”

For example, the products may be cases of beverage containers (e.g. cartons of cans, beverage crates containing bottles or cans, cardboard trays with plastic overwrap, etc). There are many different permutations of flavors, sizes, and types of beverage containers delivered to each store. When building pallets, missing or mis-picked product can account for significant additional operating costs.

The assignee of the present invention has developed a validation system in which a plurality of products stacked on a pallet or other platform are imaged. The images are then analyzed using at least one machine learning model to identify the SKUs associated with the plurality of products stacked on the pallet. The identified SKUs are then compared to the SKUs on the pick list or order. If necessary, missing products can be added or incorrect products can be corrected before the pallet is shipped to the store.

### SUMMARY

A mobile camera unit disclosed herein provides one convenient way of imaging a plurality of products stacked on a pallet or other platform. The mobile camera unit includes a base having a plurality of wheels. A support extends upward from the base. At least one camera mounted to the support. At least one processor is configured to collect images from the at least one camera. A communication circuit is configured to transmit the images. The mobile camera unit may be used to capture images of a plurality of products on a pallet or other platform. The images are transmitted to a server to identify SKUs associated with the products and to compare the identified SKUs with an order or pick list.

The at least one camera may include an upper camera and a lower camera. The operator can choose which camera is better positioned to image the plurality of products.

The mobile camera unit may include a mobile device including the at least one processor and the communication circuit. The mobile device is mounted to the support. Mobile device is connected to the camera(s).

At least one light may be supported by the support. The at least one light may include an upper light and a lower light controlled by the mobile device. The upper light and lower light may be elongated vertically.

A handle may extend rearwardly from the support. This facilitates movement and positioning of the mobile camera unit by the operator.

The mobile camera unit may be part of a validation system. A server has at least one processor and non-transitory electronic storage storing instructions which when executed by the at least one processor perform the following operations: a) receiving images from the mobile unit; and b) analyzing the images from the mobile unit to identify SKUs associated with each of a plurality of products in a stack in the images.

The present application also discloses one possible method for imaging a stack of a plurality of products in which the mobile camera unit could be used. Other methods could also be used. The proposed method may include capturing a first image of a first side of a stack of a plurality of products with a mobile camera unit, wherein the mobile camera unit includes a camera supported on wheels. The mobile camera unit may be rolled proximate a second side of the stack of the plurality of products where a second image of the second side of the stack of the plurality of products is captured with the mobile camera unit. The mobile camera unit may be rolled proximate a third side of the stack of the plurality of products, where a third of the third side of the stack of the plurality of products image is captured with the mobile camera unit. The mobile camera unit may be rolled proximate a fourth side of the stack of the plurality of products where a fourth image of the fourth side of the stack of the plurality of products may be captured with the mobile camera unit.

In the disclosed method, the stack of the plurality of products may be a first stack of a plurality of first products on a first pallet, and the method further include moving on a pair of tines the first pallet and the plurality of first products and a second pallet having a plurality of second products stacked thereon. The first pallet and plurality of first products may then be placed on a floor. Then, the second pallet and plurality of second products may be placed on the floor, spaced away from the first pallet. The products on the first pallet may be imaged with the mobile unit and the products on the second pallet may be imaged with the mobile unit.

In the method, the mobile camera unit may include a mobile device including a processor and a wireless communication circuit, and the camera may be configured to send the first image, the second image, the third image and the fourth image to the mobile device.

The method may further include receiving the first image, the second image, the third image and the fourth image at a server. The server analyzes the first image, the second image, the third image and the fourth image to identify SKUs associated with the plurality of products.

### BRIEF DESCRIPTION OF THE DRAWINGS

FIG. 1 is a perspective view of a mobile camera unit.

FIG. 2 is a front view of the mobile camera unit.

FIG. 3 is a side view of the mobile camera unit.

FIG. 4 is a rear perspective of the mobile camera unit.

FIG. 5 shows a first step in one possible method of using the mobile camera unit.

FIG. 6 shows a second step in the method of using the mobile camera unit.

FIG. 7 shows a third step in the method of using the mobile camera unit.

FIG. 8 shows one example screen of the mobile device of mobile camera unit that the worker uses when imaging a pallet.

FIG. 9 is an overhead schematic view of the method of using the mobile camera unit.

FIG. 10 shows the screen of the mobile device of the mobile camera unit indicating that the pallet has been verified.

FIG. 11 shows the screen of the mobile device of the mobile camera unit indicating that the pallet has errors.

### DETAILED DESCRIPTION

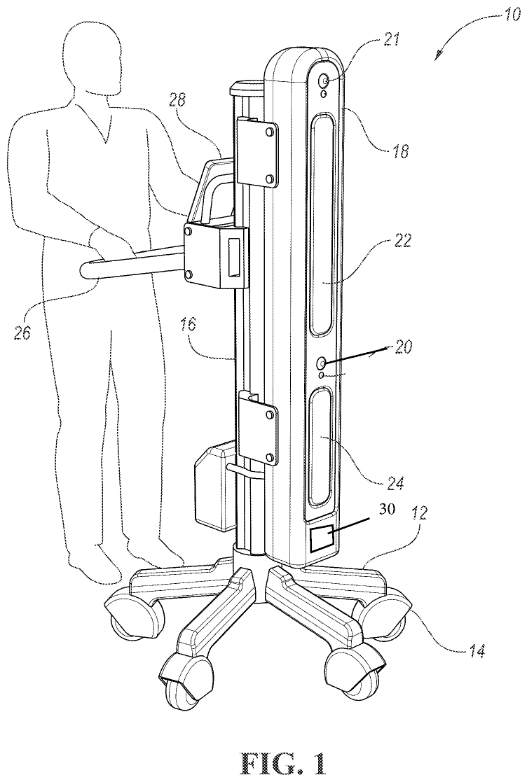

FIG. 1 shows a mobile camera unit 10 according to one example embodiment. The mobile camera unit 10 includes a base 12, which may be a five-legged base as shown. Each leg of the base 12 has a wheel 14 (such as on a caster) at a lower end so that the mobile camera unit 10 is easily movable but stable.

A cylindrical support 16 extends upward from the base 12. A housing 18 is secured to a front side of the cylindrical support 16. A lower camera 20 is mounted at a front surface of the housing 18. An upper light 22 is mounted to the front surface of the housing 18 above the lower camera 20. A lower light 24 is mounted to the front surface of the housing 18 below the lower camera 20. An upper camera 21 is mounted at the front surface of the housing 18 above the upper light 22. The upper light 22 and the lower light 24 are each elongated vertically and may be LED lights, for example.

A handle 26 extends rearward from the cylindrical support 16. A mobile device 28 is mounted above the handle 26 to the cylindrical support 16. The mobile device 28 includes at least one processor, electronic storage, a touchscreen, wireless communication circuits (such as wifi, Bluetooth, cell data, etc). The mobile device 28 may be a tablet, such as an iPad or the like. The electronic storage stores suitable programs for performing the methods described herein.

The upper light 22 and the lower light 24 are controlled by the mobile device 28 via a wired or wireless connection (e.g. Bluetooth). The lower camera 20 and upper camera 21 are digital cameras directed forwardly of the mobile camera unit 10, the cylindrical support 16 and the housing 18. The lower camera 20 and upper camera 21 may be wired directly to the mobile device 28 or connected via a wireless connection (e.g. Bluetooth). The lower camera 20 and upper camera 21 are controlled by the mobile device 28. The lower camera 20 and upper camera 21 transmit captured digital images to the mobile device 28.

An RFID reader 30 may be mounted to a lower end of the housing 18. The RFID reader 30 is connected to the mobile device 28 via a wired or wireless connection (e.g. Bluetooth).

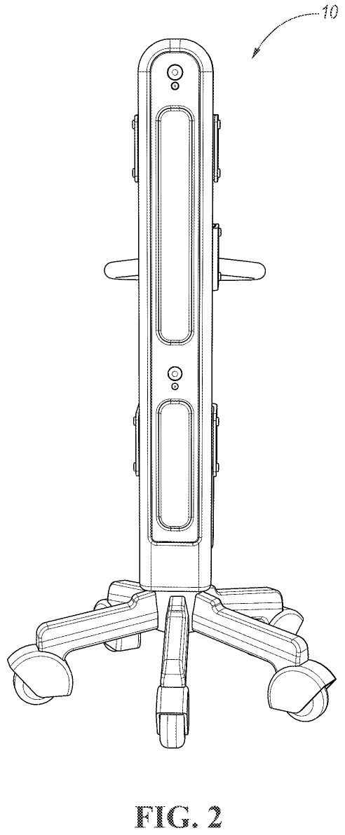

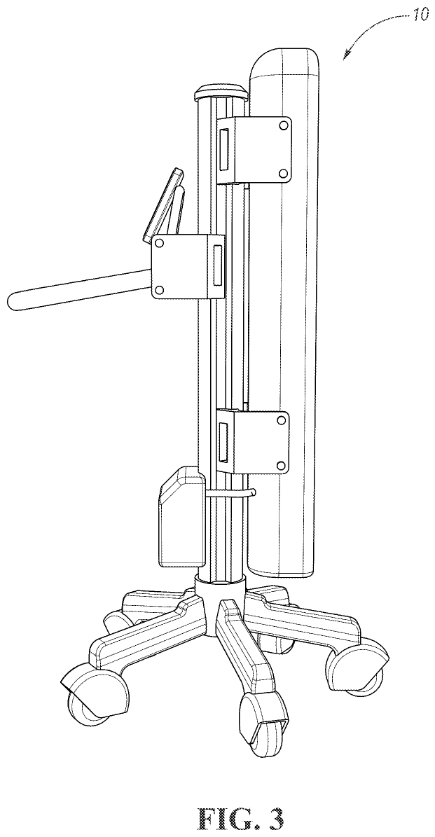

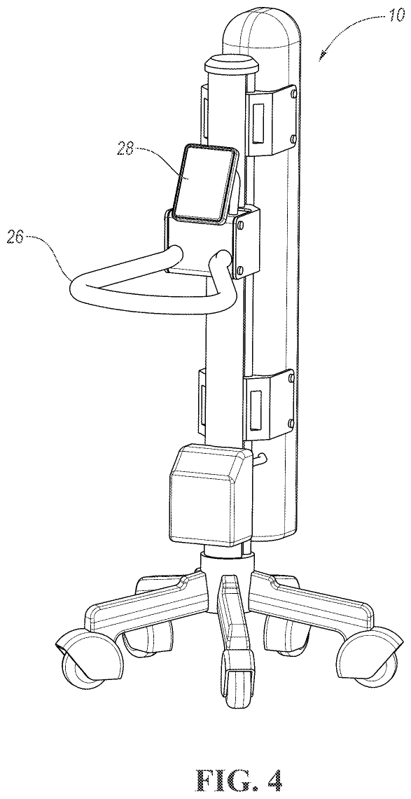

FIG. 2 is a front view of the mobile camera unit 10. FIG. 3 is a side view of the mobile camera unit 10. FIG. 4 is a rear perspective of the mobile camera unit 10.

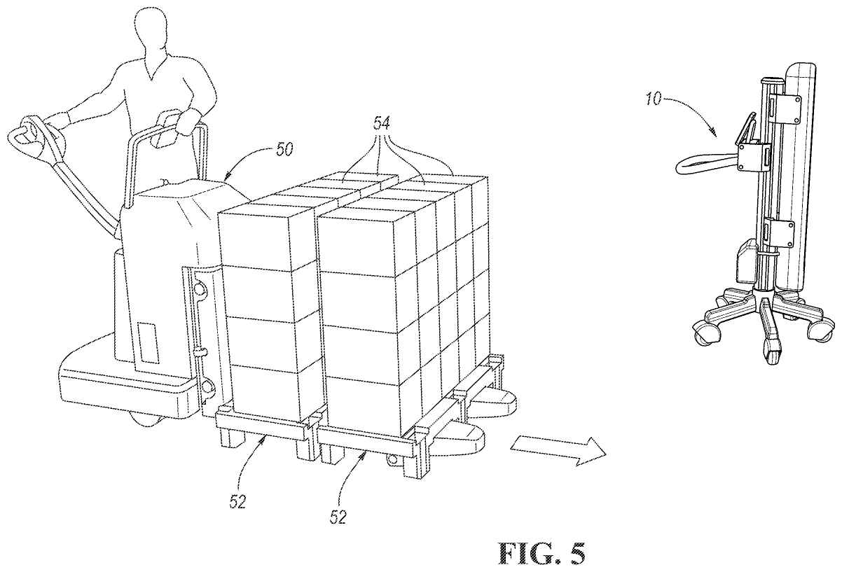

FIG. 5 shows a first step in using the mobile camera unit 10. In a distribution center, hundreds or thousands of different SKUs are stored. When an order is received, a worker loads pallets 52 on a pallet lift 50 (e.g. a pallet jack or similar) such as the one shown in FIG. 5. The worker loads products 54 onto the pallets 52 to fulfill the order or orders. Each of the products 54 is associated with one of hundreds or thousands of different SKUs available in the distribution center. The products 54 may be packages of beverage containers.

A “SKU” may be a single variation of a product that is available from the distribution center and can be delivered to one of the stores. For example, if the products 54 are packages of beverage containers, each SKU may be associated with a particular package type, e.g. the number of containers (e.g. 12 pack) in a particular form (e.g. can v bottle) and of a particular size (e.g. number of ounces) optionally with a particular secondary container (cardboard, reusuable plastic crate, cardboard tray with plastic overwrap, etc). In other words, the package type may include both primary packaging (can, bottle, etc, in direct contact with the beverage or other product) and any secondary packaging (crate, tray, cardboard box, etc, containing a plurality of primary packaging containers).

Each SKU may also be associated with a particular “brand” (e.g. the manufacturer and the specific variation, e.g. flavor, diet, etc). The “brand” may also be considered to be the specific content of the primary package and secondary package (if any) for which there is a package type.

It is also possible that more than one variation of a product may share a single SKU, such as where only the packaging, aesthetics, and outward appearance of the product varies, but the content and quantity/size is the same. For example, sometimes promotional or seasonal packaging may be utilized, which would have different image information for a particular SKU, but it is the same beverage in the same primary packaging with secondary packaging having different colors, text, and/or images. Alternatively, the primary packaging may also be different (but may or may not be visible, depending on the secondary packaging).

Referring again to FIG. 5, after the worker loads the pallets 52 to fill the order or orders, the worker uses the pallet lift 50 to bring the pallets 52 to an area near the mobile camera unit 10.

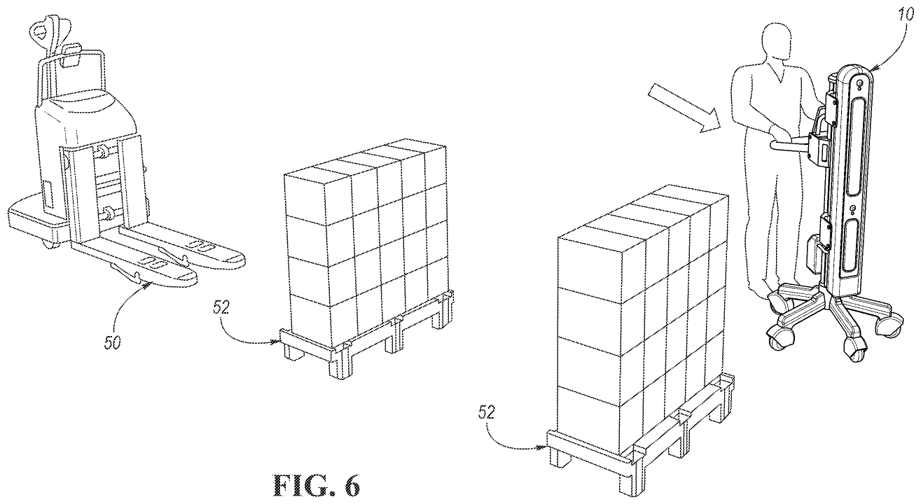

As shown in FIG. 6, the worker places both pallets 52 on the floor, spaced apart from one another. The worker moves the pallet lift 50 away from the pallets 52.

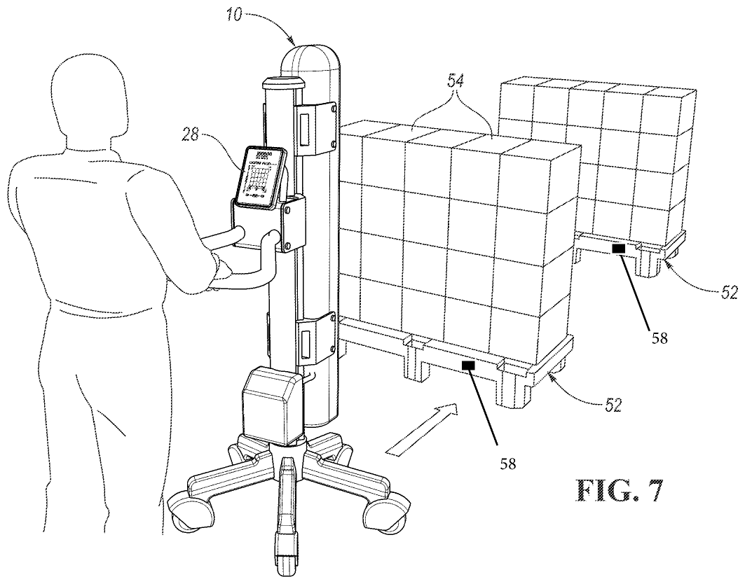

Referring to FIG. 7, the worker (or a different worker) then rolls the mobile camera unit 10 to a position where the lower camera 20 or upper camera 21 (FIG. 1) can take an image of one side of one of the loaded pallets 52. The worker can choose whether to use the lower camera 20 or upper camera 21 or both. The mobile device 28 causes the RFID reader 30 to read an RFID tag 58 on each of the pallets 52.

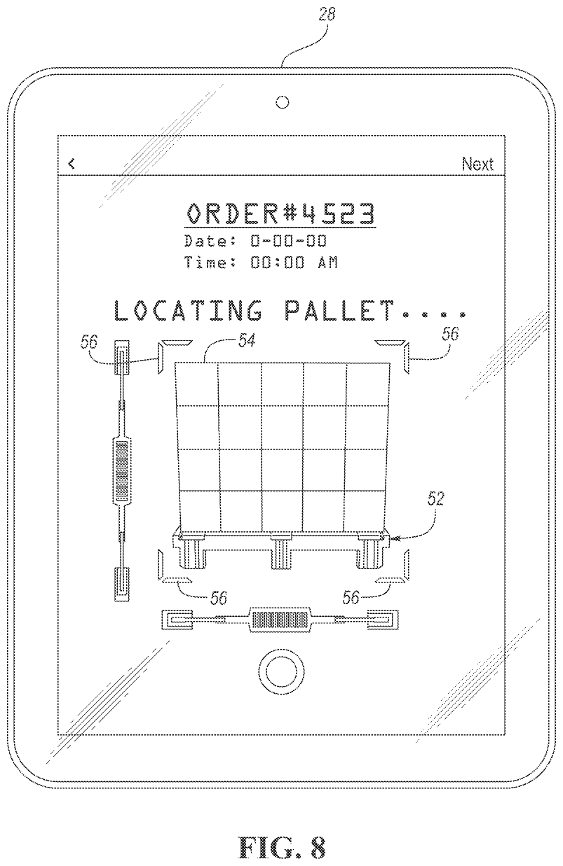

FIG. 8 shows one example screen of the mobile device 28 of mobile camera unit 10 that the worker uses when imaging a pallet 52. The mobile device 28 displays a real time image of the pallet 52 and the products 54 on the pallet 52. Fiducials 56 are displayed on the screen overlaying the real time image to assist the worker in aligning the lower camera 20 (or upper camera 21) to take a good image of the pallet 52 and products 54. The mobile device 28 processes the real time image to detect the relative location of the pallet 52 and products 54. Based upon this processing, the mobile device may display feedback to the worker, such as “move closer,” “move back,” “move right,” “move left,” etc. The mobile device 28 may also warn if the lighting is poor or the image is blurry. When the mobile device 28 determines that the pallets 52 and products 54 are in an optimal relative location and orientation, the mobile device 28 captures the image (via lower camera 20 and/or upper camera 21) either automatically or based upon the user touching a button on the screen. The mobile device 28 then instructs the worker to image another side of the loaded pallet 52 (e.g. by displaying “Move to next side of the pallet”).

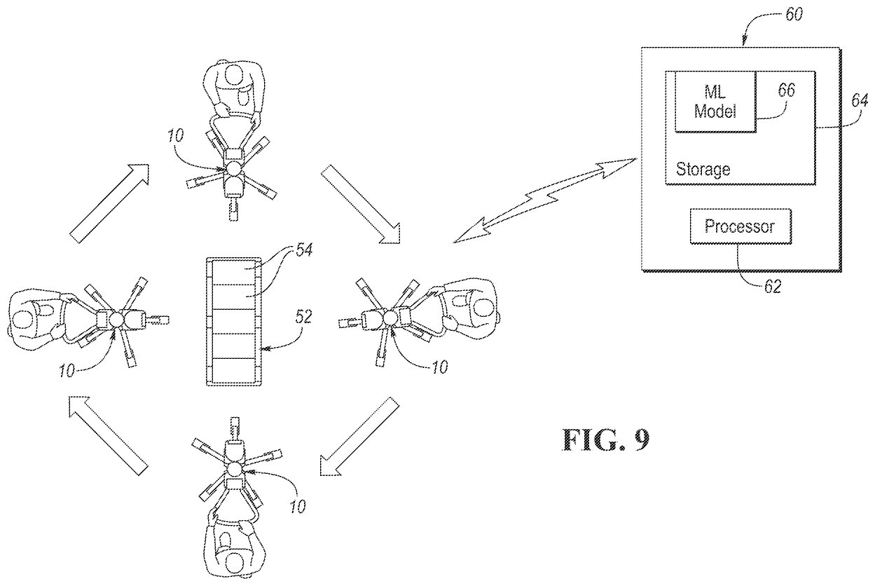

As shown in FIG. 9, the worker moves the mobile camera unit 10 around each loaded pallet 52 (one shown) to four positions, so that the mobile camera unit 10 can image each of the four sides of the loaded pallet 52. An image is taken of each side of the loaded pallet 52. This is repeated for the other pallet 52 (FIG. 8). These images are sent to a server 60 by the mobile device 28 (e.g. via a wifi or Bluetooth circuit in the mobile device 28) along with the pallet id (from RFID tag 58) associated with that pallet 52.

The server 60 includes at least one processor 62 and suitable storage 64. The storage 64 stores at least one machine learning model 66 that is trained on known images of the SKUs. The storage 64 includes at least one non-transitory computer-readable medium that also stores instructions that, when executed by the at least one processor, cause the at least one processor 62 to perform the operations described herein.

The package type and brand information of each possible SKU is stored by the server 60 and associated with the SKU along with the name of the product, a description of the product, dimensions of the product, and optionally the weight of the product. This SKU information is associated with image information for that SKU in the machine learning model(s).

The server 60 processes the images from the mobile camera unit 10 for each loaded pallet 52 and using the at least one machine learning model 66 identifies the SKUs associated with each product 54 on the pallet 52. The identified SKUs are then compared to the SKUs on the associated order or pick sheet that was used to load the products onto the pallet 52.

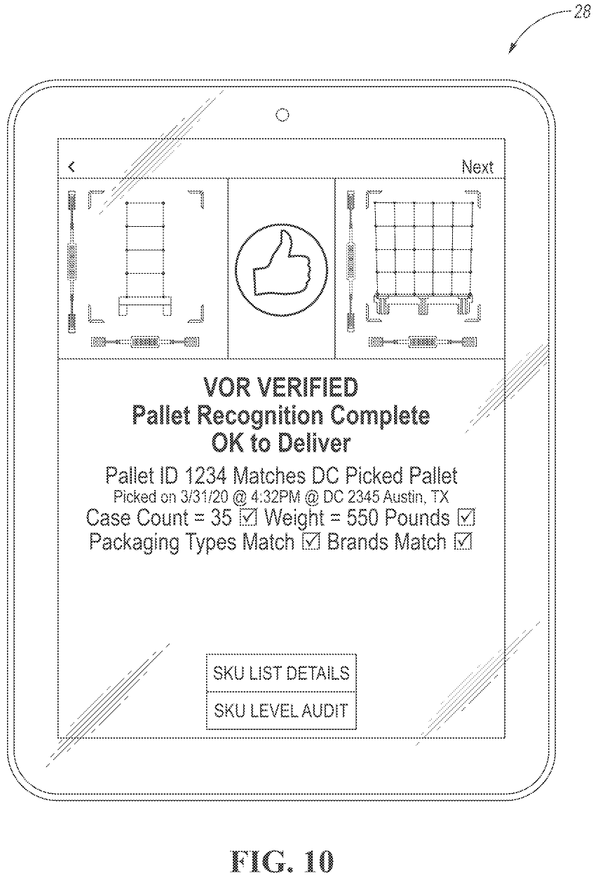

If the identified SKUs on the loaded pallet 52 match the associated pick sheet, then a positive confirmation screen is displayed to the worker on the mobile device 28 as shown in FIG. 10. Details regarding the loaded pallet 52 may also be displayed and logged, such as Pallet ID, Date and time pallet was picked, identification and location of the distribution center, case count (i.e. number of products), weight (if available from a separate scale, not shown), confirmation that packaging types matched and confirmation that brands matched. The worker can also choose to see more detail about the SKU list or perform a SKU level audit.

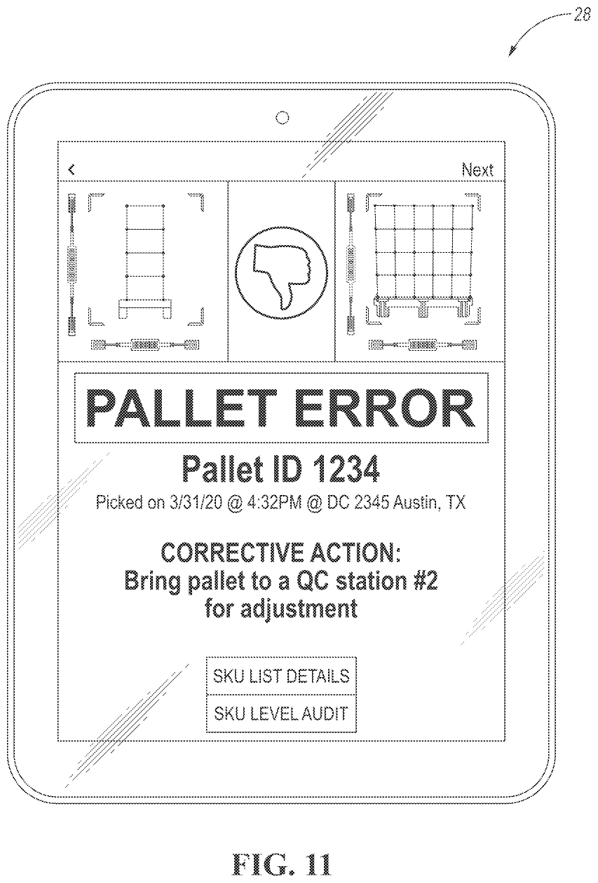

If the SKUs identified on the loaded pallet 52 do not match the associated pick sheet, then the negative confirmation screen is displayed to the worker on the mobile device 28 as shown in FIG. 11. Again, pallet id, date, time location and displayed (and logged). The worker is then instructed to bring the pallet 52 to a particular QC station for adjustment. Again, the worker can also choose to see more detail about the SKU list or perform a SKU level audit.

It should be understood that each of the computers, servers or mobile devices described herein includes at least one processor and at least one non-transitory computer-readable media storing instructions that, when executed by the at least one processor, cause the computer, server, or mobile device to perform the operations described herein. The precise location where any of the operations described herein takes place is not important and some of the operations may be distributed across several different physical or virtual servers at the same or different locations.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers on method claims steps are for convenient reference in dependent claims and do not indicate a required sequence unless a sequence is explicitly recited.

What is claimed is:

1. A mobile camera unit comprising:
a base having a plurality of wheels;
a support extending upward from the base;
at least one camera mounted to the support;
at least one processor collecting images from the at least one camera; and
a communication circuit for transmitting the images.

2. The mobile camera unit of claim 1 wherein the at least one camera includes an upper camera and a lower camera.

3. The mobile camera unit of claim 1 further including a mobile device including the at least one processor and the communication circuit, wherein the mobile device is mounted to the support.

4. The mobile camera unit of claim 3 further including at least one light supported by the support.

5. The mobile camera unit of claim 4 wherein the at least one light includes an upper light and a lower light controlled by the mobile device.

6. The mobile camera unit of claim 1 further including a handle extending rearwardly from the support, wherein the at least one camera is directed forwardly of the support.

7. The mobile camera unit of claim 1 further including an RFID reader.

8. A validation system including the mobile camera unit of claim 1 and further including a server having at least one processor and non-transitory electronic storage storing instructions which when executed by the at least one processor cause the at least processor to perform the following operations:
a) receiving images from the mobile unit; and
b) analyzing the images from the mobile unit to identify SKUs associated with each of a plurality of products in a stack in the images.

9. A method for imaging a stack of a plurality of products including:
a) capturing a first image of a first side of a stack of a plurality of products with a mobile camera unit, wherein the mobile camera unit includes a camera supported on wheels;
b) rolling the mobile camera unit proximate a second side of the stack of the plurality of products;
c) after step b), capturing a second image of the second side of the stack of the plurality of products with the mobile camera unit;
d) rolling the mobile camera unit proximate a third side of the stack of the plurality of products;
e) after step d), capturing a third image of the third side of the stack of the plurality of products with the mobile camera unit;
f) rolling the mobile camera unit proximate a fourth side of the stack of the plurality of products; and
g) after step f), capturing a fourth image of the fourth side of the stack of the plurality of products with the mobile camera unit.

10. The method of claim 9 wherein the stack of the plurality of products is a first stack of a plurality of first products on a first pallet, the method further including the steps of:
h) moving on a pair of tines the first pallet and the first stack of the plurality of first products and a second pallet having a second stack of a plurality of second products thereon;
i) after step h), placing the first pallet and the first stack of the plurality of first products on a floor;
j) after step i), placing the second pallet and the second stack of the plurality of second products on the floor, spaced away from the first pallet; and
k) after step i), performing steps a) to g).

11. The method of claim 10 wherein the mobile camera unit includes a mobile device including a processor and a wireless communication circuit, and wherein the camera is configured to send the first image, the second image, the third image and the fourth image to the mobile device.

12. The method of claim 11 further including:
h) receiving the first image, the second image, the third image and the fourth image at a server; and
i) the server analyzing the first image, the second image, the third image and the fourth image to identify SKUs associated with the plurality of first products.

13. The method of claim 12 further including reading an RFID tag on the first pallet.

14. A mobile camera unit comprising:
a base having a plurality of wheels;
a support extending upward from the base;
an upper camera mounted to the support and directed forwardly of the mobile camera unit;
a lower camera mounted to the support and directed forwardly of the mobile camera unit; and
a mobile device mounted to the support, the mobile device including at least one processor, the mobile device configured to collect images from the upper camera and the lower camera, the mobile device further including a communication circuit configured to transmit the images.

15. The mobile camera unit of claim 14 further including a handle extending rearwardly of the support.

16. The mobile camera unit of claim 15 further including at least one light supported by the support.

17. The mobile camera unit of claim 16 wherein the at least one light includes an upper light and a lower light, wherein the upper light and the lower light are controlled by the mobile device.

18. The mobile camera unit of claim 17 wherein the upper light is elongated vertically.

19. The mobile camera unit of claim 18 further including an RFID reader mounted to the support.
